(19) United States
(12) Patent Application Publication
(10) Pub. No.: US 2007/0150485 A1
(43) Pub. Date: Jun. 28, 2007

(54) Navigating through a displayed hierarchical data structure

(75) Inventor: Frank Uittenbogaard, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, Eindhoven (NL)

(21) Appl. No.: 10/572,615

(22) PCT Filed: Sep. 1, 2004
(86) PCT No.: PCT/IB04/51645

§ 371 Date: Mar. 17, 2006

(30) Foreign Application Priority Data
Sep. 22, 2003 (EP) 03103491.1

(51) Int. Cl. G06F 7/00

(52) U.S. Cl. 707/100

(57) ABSTRACT

The invention relates to a method for navigating through a displayed hierarchical data structure including a parent node and a plurality of child nodes the method comprising: displaying the parent node at a parent position, displaying each of the plurality of child nodes at a respective child node position; assigning a parent relevance grade to the parent node and assigning a respective relevance grade to each of the plurality of child nodes; navigating through the displayed hierarchical data structure; hiding, upon navigation through the displayed hierarchical data structure, a child node of the plurality of child nodes, based upon the respective relevance grade of child node; and displaying a reference node (200) at a reference node position in stead of displaying the hidden child node, wherein the reference node position is related to the child node position. The invention further relates to a system for navigating through a displayed hierarchical data structure including a parent node and a plurality of child nodes. The invention further relates to a computer readable medium having stored thereon instructions for causing one or more processing units to perform such a method.

The invention relates to a method for navigating through a displayed hierarchical data structure including a parent node and a plurality of child nodes, the method comprising: displaying the parent node at a parent position, displaying each of the plurality of child nodes at a respective child node position.

The invention further relates to a system for navigating through a displayed hierarchical data structure including a parent node and a plurality of child nodes the system comprising: display means conceived to display the parent node at a parent position, and to display each of the plurality of child nodes at a respective child node position.

The invention further relates to a computer readable medium having stored thereon instructions for causing one or more processing units to perform such a method.

An embodiment of such a method and system is disclosed in U.S. Pat. No. 6,430,574. Here, a method and apparatus is disclosed that can scroll a displayed hierarchical data structure. This hierarchical data structure can include a first parent node and a plurality of child nodes of the parent node, the plurality of subordinated nodes including a first child node and a second child node. The first parent node can be displayed in a first position of a display area. The first child node can be displayed in a second position of the display area, the second position being adjacent to the first position. The second child node can be displayed in the display area. A first instruction to scroll at least the second child node in a direction toward the first position can be received, and the second child node can be displayed in the second position. Child nodes can be displayed or completely hidden depending upon the scrolling direction though the displayed the hierarchical data structure. An indicator is shown adjacent to the displayed nodes. The indicator visualizes the proportion of the child nodes of a parent node that are currently displayed, and that are currently hidden.

It is an object of the invention to provide a method according to the opening paragraph that visualizes nodes within a hierarchical data structure in an improved way. To achieve this object, the method comprises: assigning a parent relevance grade to the parent node and assigning a respective relevance grade to each of the plurality of child nodes; navigating through the displayed hierarchical data structure; hiding, upon navigation through the displayed hierarchical data structure, a child node of the plurality of child nodes, based upon the respective relevance grade of the child node; and displaying a reference node at a reference node position in stead of displaying the hidden child node, wherein the reference node position is related to the child node position. By assigning a relevance grade to a node, the relevance grade can be used to determine if the node should remain displayed or if the node should be hidden. Therefore, the relevance grade can be used, for example, in the case that a user performs a scrolling operation upon the hierarchical data structure to hide nodes in order to save space upon a display device.

An embodiment of the method according to the invention is described in claim 2. By displaying a reference node in stead of the hidden node, the hidden node can be displayed again by selecting the reference node. Thereby providing a user easy access, my means of only a single mouse click, to the hidden nodes.

An embodiment of the method according to the invention is described in claim 3. By hiding the nodes in the opposite direction than the direction of navigation, those nodes are hidden within an area of the display that is of less importance to the user.

An embodiment of the method according to the invention is described in claim 4. By making the relevance grade dependent upon for example the number of child nodes of a parent node, only nodes are hidden that have for example no child nodes. In the case that, for example, the relevance grade depends upon if a user has selected a node, only nodes are hidden that are for example not selected by the user.

An embodiment of the method according to the invention is described in claim 5. By assigning a ordering to the relevance grade, nodes can be hidden based upon the order of relevance grade of the node. Thereby providing stepwise hiding of nodes, dependent upon the amount of space that is available for displaying the hierarchical data structure.

An embodiment of the method according to the invention is described in claim 6. In the case that the displayed reference node reflects for example the number of child nodes, the user can easily derive how many child nodes are hidden and how many child nodes the user can access by selecting the displayed reference node.

It is an object of the invention to provide a system according to the opening paragraph that that visualizes nodes within a hierarchical data structure in an improved way. To achieve this object, the system comprises assign means conceived to assign a parent relevance grade to the parent node and assign a respective relevance grade to each of the plurality of child nodes; navigation means conceived to navigate through the displayed hierarchical data structure; hiding means conceived to hide, upon navigation through the displayed hierarchical data structure, a child node of the plurality of child nodes, based upon the respective relevance grade of the child node; and the display means is further conceived to display a reference node at a reference node position in stead of displaying the hidden child node, wherein the reference node position is related to the child node position.

These and other aspects of the invention will be apparent from and elucidated with reference to the embodiments described hereinafter as illustrated by the following FIGS:

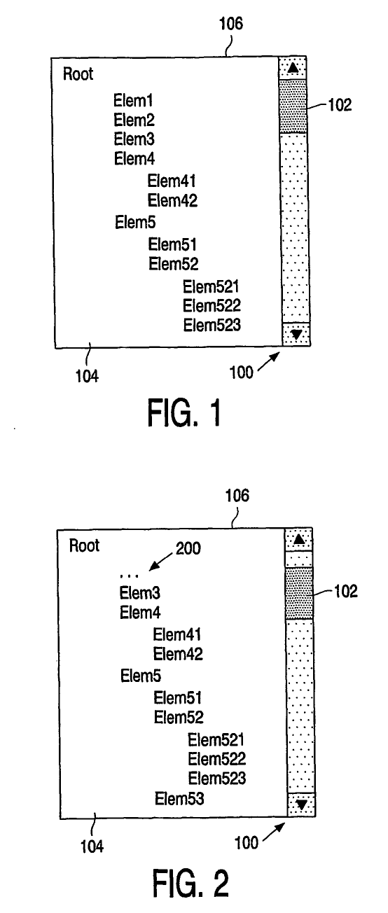

FIG. 1 illustrates a hierarchical data structure in an initial state;

FIG. 2 illustrates a hierarchical data structure in a further state;

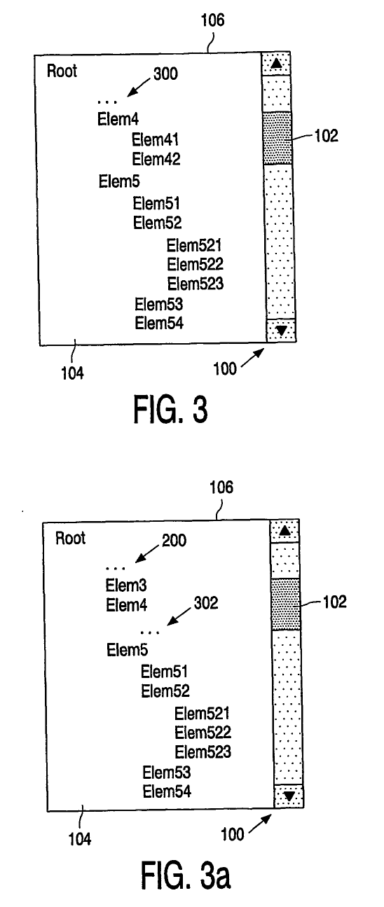

FIG. 3 illustrates a hierarchical data structure in a further state;

FIG. 3a illustrates a hierarchical data structure in a further state;

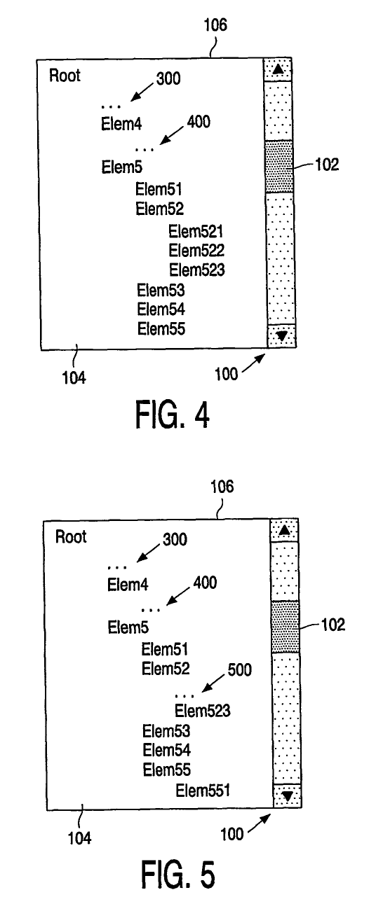

FIG. 4 illustrates a hierarchical data structure in a further state;

FIG. 5 illustrates a hierarchical data structure in a further state;

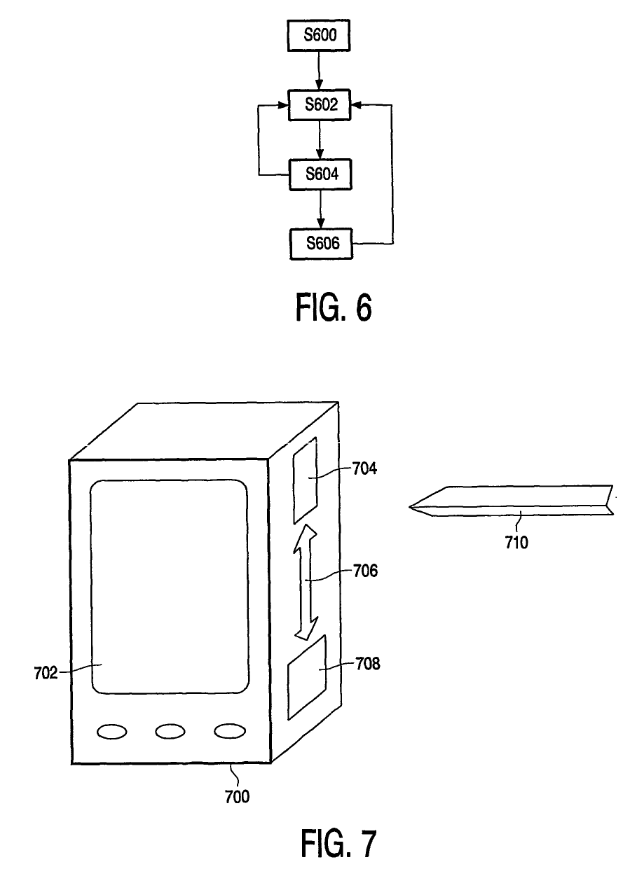

FIG. 6 illustrates an embodiment of the method according to the invention in a schematic way;

FIG. 7 illustrates a personal digital assistant (pda) in a schematic way.

Tree structures are widely used in all kinds of software applications. Examples are directory structures in file managers, menu systems comprising submenus, content organization in on-line documentation etc. If they need to be presented to the user, they are normally represented as an indented list, starting with a non-indented root element (e.g. the main directory) on a first line, followed by indented sub-elements, each on a separate succeeding line. Each sub-element can have further sub-elements, which are shown right below that sub-element at a next level of indentation.

Often, the user may expand or collapse individual elements, to display or hide sub-elements of a particular (sub-)element. “Selecting” an element at any level often has some specific effect, e.g. in a file manager selecting a (sub)directory may cause displaying the files it contains in a separate window. Sometimes, selection of an element causes its expansion or another effect dependent on whether it has sub-elements. For example, selection of a menu item in a menu system may cause displaying a submenu, or if there is no sub-menu, the invoking of the corresponding function.

A tree structure can be quite extensive, so its graphical representation may be a long list comprising multiple levels of indentation and requiring more lines than can be displayed on the screen. Most applications provide a scroll-bar for scrolling the list upward and downward to enable the user to select, expand or collaps any desired (sub)element. A problem of such conventional systems is that the user might easily get lost. For example, after scrolling downward several times, and maybe expanding/collapsing several nodes, it may be very difficult to remember where and at which level the visible elements are located. In an extreme example, all visible elements may be of the same, but unknown, level, leaving the user no clue as to which level they actually belong, let alone that the user has an idea of the overall tree structure.

FIGS. 1 to 5 show an example of a tree structure representation in successive scroll states. FIG. 6 illustrates an embodiment of the method according to the invention in a schematic way. FIGS. 1 to 5 are used to explain the embodiment of the method. Within the first step S600, a relevance grade is assigned to each element in a hierarchical data structure, also referred to as “tree list”, which determines whether a particular element will be shown in a particular scroll state.

In a simple case, only two grades are assigned: relevant and irrelevant. Possible assignments may be:
expanded nodes relevant (including the root), other nodes irrelevant;
expandable nodes relevant (no matter whether they are actually expanded or collapsed), other nodes irrelevant;
relevant are expanded (expandable) nodes and nodes which in the current context have some additional relevance, e.g. nodes which are currently selected or highlighted by the user for some purpose.

Here, an expandable node is a node that has child nodes that can be displayed.

In FIG. 1 a hierarchical data structure is shown in an initial state. The root element and elements Elem4, Elem5 and Elem52 are expanded, Elem3 has sub-elements but is in collapsed state, and the other elements are leaf elements. The data structure is displayed within window 100 and can be navigated by scroll bar 102. The scroll bar can be navigated by using an input device like a mouse, a stylus, a keyboard etc. The scroll bar 102 can be operated by a user to navigate to the bottom 104 or to the top 106 of window 100.

Within the next step S602, the user uses scroll bar 102 to navigate one row down to the bottom 104 of window 100. Now, the root element remains displayed at its present position because as an expanded node it is relevant for understanding the structure of the tree.

Within the next step S604, Elem1 is replaced by a reference element 200 (‘. . . ’), see FIG. 2, to indicate that Elem1 is replaced by the reference element 200 at that position. This reference element 200 may be inserted between two lines to save a line. Alternatively, as shown in FIG. 2, it occupies a regular line, in which case both Eleml and Elem2 are replaced by the reference element 200. Otherwise Elem1 would just be replaced by reference element 200 and reference element 200 would occupy one line too, giving no space-saving scrolling effect.

Step S602 can be repeated again after step S604, scrolling down one further line, thereby causing Elem3 to be hidden and replaced by reference element 300 as shown in FIG. 3.

Alternatively, Elem3 remains in de displayed list because it is an expandable node, and Elem41 and Elem42 are hidden, i.e. replaced by reference element 302 as shown in FIG. 3a. This enables the user to expand Elem3 without having to scroll upwards to the top 106 of window 100 first.

Further scrolling down is illustrated in FIG. 4 and 5. Within FIG. 4, Elem41 and Elem42 are replaced by reference element 400. Within FIG. 5, Elem521 and Elem522 are replaced by reference element 500, and so on. Hiding Elem51 would not make sense because the reference element would occupy the same line. However, if the reference indicator were presented between two regular lines, hiding Elem51 would be appropriate.

The reference elements 200, 300, 302, 400 and 500 may be presented as a hyperlink or button, or an other user interface element that can be selected by the user.

Within the next step S606, the user selects reference element 500 by for example clicking the reference element 500. Now, since reference element represents the hidden Elem521, and Elem522, these two elements are displayed again and the state of FIG. 4 is restored. Thus, the reference elements 200, 300, 302, 400 and 500 are shortcuts to restore the original state of the hidden elements they represent. If, for example reference element 400 is selected, the state of FIG. 3 is restored, wherein Elem41 and Elem42 are displayed. The user can, by selecting the reference items, navigate easily to a desired position within the hierarchical structure, without having to operate the scroll bar.

At any level within the hierarchical structure, one or more reference elements may occur. Clicking any of these reference elements causes at least the hidden elements represented by the reference element to be displayed again. In an alternative embodiment all reference elements below the selected reference element in the list are also replaced by their corresponding hidden elements, thus effectively performing a scroll-up operation.

Instead of starting to hide elements at the top of the hierarchical structure in response to scrolling down, the moment of hiding could be made dependent on the level in the tree structure. For example, start hiding elements at the deepest level. Then, starting from FIG. 1, scrolling down would successively hide elements Elem521, Elem522 and Elem523, then Elem41 and Elem42, and finally Elem1 and Elem2.

Instead of or in addition to the expandable aspect of a node, other aspects may be taken into account as well. For example, the tree structure may represent a topic or genre taxonomy, from which multiple topics may be selected, e.g. to enter preferred topics or genres into a user profile. Highlighting the selected elements or displaying a check mark in front of them may indicate selection of the element. Scrolling down the tree could hide the unselected elements and the non-expandable elements only. Also conceivable is a two-stage approach, wherein first the unselected elements are hidden, then the selected elements and finally the expanded or expandable elements. In that case, multiple relevance grades are applied.

Further, the visualization of the reference element can depend upon the number of hidden elements it represents. For example, in the case four elements are hidden, the reference element can be visualized by a string containing four dots, a dot for each hidden element: “ . . . ”, or by a colour representing the four elements, or by a button of a size representing four elements, etc.

The displayed elements can be hidden again by scrolling down as described within step S602. In stead of scrolling down, a user can scroll up or in any other direction that is appropriate for navigating through the displayed structure.

FIG. 7 illustrates a personal digital assistant (pda) in a schematic way. The pda 700 comprises a display area 702, a random access memory (RAM) 704, a central processing unit (CPU) 708 and a software bus 706. A user can (amongst others) operate the pda using a stylus 710. The software bus 706 communicatively connects the display area 702, the RAM 704 and the CPU 708 with each other. The RAM 704 memory comprises computer readable code that is designed to perform the method steps according to the invention as previously described. The display area 702 is designed to display the output of the pda 700 such as the hierarchical data structures as shown in FIGS. 1 to 5. The pda is an example of a display device; other examples are: a mobile phone, global positioning system (gps) device, Television Set (TV), etc.

The order in the described embodiments of the method of the current invention is not mandatory, a person skilled in the art may change the order of steps or perform steps concurrently using threading models, multi-processor systems or multiple processes without departing from the concept as intended by the current invention. Further the method of the current invention can be distributed onto a computer readable medium having stored thereon instructions for causing one ore more processing units to perform this method. A computer readable medium is for example a Compact Disk (CD) Digital Versatile Disk (DVD), DVD+RW etc. A processing unit is for example a microprocessor. The instructions can also be downloaded from a server via the internet or from an other portable digital assistant (pda) or mobile phone using a wireless application protocol (wap) interface.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. Method for navigating through a displayed hierarchical data structure including a parent node and a plurality of child nodes the method comprising:
displaying the parent node at a parent position, displaying each of the plurality of child nodes at a respective child node position;
assigning a parent relevance grade to the parent node and assigning a respective relevance grade to each of the plurality of child nodes;
navigating through the displayed hierarchical data structure;
hiding, upon navigation through the displayed hierarchical data structure, a child node of the plurality of child nodes, based upon the respective relevance grade of child node; and
displaying a reference node at a reference node position in stead of displaying the hidden child node, wherein the reference node position is related to the child node position.

2. A method according to claim 1, the method comprising:
selecting the reference node; and
displaying the child node at the child node position in stead of displaying the reference node, upon selecting the reference node.

3. A method according to claim 1, wherein navigating through the displayed hierarchical data structure and hiding the child node are in opposite directions.

4. A method according to claim 1, wherein the relevance grade depends upon at least one of: a number of child nodes of the parent node, a selected child node or a selected parent node.

5. A method according to claim 1, wherein the relevance grade comprises an ordering and hiding the child node depends upon this ordering.

6. A method according to claim 1, wherein the displayed reference node reflects a number of child nodes, of the plurality of child nodes, which are hidden.

7. System for navigating through a displayed hierarchical data structure including a parent node and a plurality of child nodes the system comprising:
display means (702) conceived to display the parent node at a parent position, and to display each of the plurality of child nodes at a respective child node position;
assign means (704) conceived to assign a parent relevance grade to the parent node and assign a respective relevance grade to each of the plurality of child nodes;
navigation means (710) conceived to navigate through the displayed hierarchical data structure;
hiding means (704) conceived to hide, upon navigation through the displayed hierarchical data structure, a child node of the plurality of child nodes, based upon the respective relevance grade of the child node; and
the display means (702) is further conceived to display a reference node at a reference node position in stead of displaying the hidden child node, wherein the reference node position is related to the child node position.

8. A system according to claim 8, the system comprising:
selecting means (710) conceived to select the reference node; and
the display means (702) is further conceived to display the child node at the respective child node position in stead of displaying the reference node, upon selecting the reference node.

9. Computer readable medium having stored thereon instructions for causing one or more processing units to perform the method according to claim 1.
